(19) United States
(12) Patent Application Publication
(10) Pub. No.: US 2026/0331842 A1
(43) Pub. Date: Oct. 22, 2026

(54) TRANSMISSION CABLE

(71) Applicant: ELKA INTERNATIONAL LTD., New Taipei City (TW)

(72) Inventors: Yi-Chieh CHENG, New Taipei City (TW); Yen-Tung CHEN, New Taipei City (TW)

(73) Assignee: ELKA INTERNATIONAL LTD., New Taipei City (TW)

(21) Appl. No.: 19/637,712

(22) Filed: Apr. 2, 2026

(30) Foreign Application Priority Data
Apr. 16, 2025 (TW) 114114383

(51) Int. Cl. H01R 13/66

(52) U.S. Cl. CPC H01R 13/6691

(57) ABSTRACT

A transmission cable includes a wire set and a first connector disposed at a first end of the wire set. The first connector includes a first connector circuit board having a wire-set connection pad group, and an active chip disposed on the first connector circuit board. A first power supply terminal of the active chip is electrically connected to a VCONN connection pad of the wire-set connection pad group. The wire set includes a first signal transmission unit. The first signal transmission unit includes a first signal transmission wire and a first drain wire. The first signal transmission wire is electrically connected to a first signal transmission pad of the wire-set connection pad group, and the first drain wire is electrically connected to the VCONN connection pad.

### CROSS-REFERENCE TO RELATED APPLICATIONS

This application claims the benefit of priority to Taiwan Patent Application No. 114114383, filed on Apr. 16, 2025. The entire content of the above-referenced application is incorporated herein by reference.

### TECHNICAL FIELD

The present invention relates to a transmission cable, and more particularly, to a transmission cable for optimizing the voltage drop at both ends thereof.

### BACKGROUND

With the advancement of technology, functional differences among transmission cables have become increasingly significant. Even transmission cables having the same type of connector may exhibit substantially different functionalities due to variations in configuration or chip selection. Taking USB Type-C transmission cables as an example, a USB Type-C transmission cable may be configured to provide different power delivery capabilities (e.g., 3-5 amperes or 5-20 volts), to support or not support video transmission, and to operate at different data transmission speeds. Since a single USB Type-C transmission cable may have different capability configurations, an active chip (e.g., an E-marker) is required to record various capability attributes of the transmission cable, such as power delivery capability, data transmission capability, video transmission capability, and identification information.

The active chip of a transmission cable may be powered by a device connected to one end of the transmission cable. For example, FIG. 1 illustrates a connection configuration of an active chip P11 of a conventional transmission cable P1. The conventional transmission cable P1 may include a first connector P10 and a second connector P30 disposed at two ends thereof, and a wire set P20 connecting the first connector P10 and the second connector P30. The active chip P11 of the conventional transmission cable P1 may be disposed in one or both of the connectors P10, P30 and supplied with power through the connectors P10, P30. Specifically, the active chip P11 may include two voltage connection (VCONN) ports VCONN1 and VCONN2, which are respectively connected to VCONN terminals of the first connector P10 and the second connector P30. When the conventional transmission cable is connected to a first device P2 and a second device P3, the first device P2 and the second device P3 may determine a data role (e.g., downstream facing port (DFP), upstream facing port (UFP), or dual-role data (DRD)) or a power supply mode through configuration control (CC) ports of the active chip P11. Thereafter, a protocol determines whether the first device or the second device supplies power to the active chip.

In practical applications, the wire set of a transmission cable is often constrained by physical limitations of the cable structure. Electrical impedance of the wire set may cause energy loss, such that a voltage drop occurs between two ends of the transmission cable (e.g., between VBUS or VCONN terminals), resulting in signal level shift or deviation and consequently leading to functional failure or malfunction. For example, when a power supply terminal of the active chip becomes unstable due to excessive voltage drop, the active chip may fail to operate as intended. Such issues become more pronounced in long-distance transmission scenarios.

To address voltage drop or signal loss caused by electrical impedance of the wire set, a conventional approach is to increase the wire gauge of conductors in the wire set. However, such an approach may increase stiffness of the transmission cable, thereby making it difficult to bend or install or installation and reducing user convenience. It should be noted that voltage drop issues are not limited to long-distance transmission applications. For short-distance transmission applications, using a wire set with a smaller cross-sectional area may provide advantages such as reduced cable cost and improved flexibility.

Accordingly, there is a need for a solution to reduce signal and/or energy attenuation caused by inherent impedance of a transmission cable without increasing the wire gauge of the wire set, or under a requirement of reducing the wire gauge of the transmission cable, has become a significant technical challenge in the field of transmission cable development.

### SUMMARY

One of the objectives of the present invention is to reduce voltage drop at two ends of a transmission cable, so as to prevent failure of an active chip or loss of functionality of the transmission cable caused by voltage drop.

The present invention provides a transmission cable. The transmission cable includes a wire set and a first connector disposed at a first end of the wire set. The first connector includes a first connector circuit board having a wire-set connection pad group, and an active chip disposed on the first connector circuit board. A first power supply port of the active chip is electrically connected to a VCONN connection pad of the wire-set connection pad group. The wire set includes a first signal transmission unit. The first signal transmission unit includes a first signal transmission wire and a first drain wire. The first signal transmission wire is electrically connected to a first signal transmission pad of the wire-set connection pad group, and the first drain wire is electrically connected to the VCONN connection pad.

In one embodiment, the wire set further includes a shielding layer that at least partially covers the signal transmission unit and is electrically connected to a ground pad of the wire-set connection pad group.

In one embodiment, the first drain wire is disposed on an auxiliary VCONN connection pad of the wire-set connection pad group, and is electrically connected to the VCONN connection pad through a conductive trace of the first connector circuit board.

In one embodiment, the auxiliary VCONN connection pad is disposed adjacent to the first signal transmission pad.

In one embodiment, the auxiliary VCONN connection pad is disposed at a corner position of the first connector circuit board.

In one embodiment, the wire set further includes a VCONN transmission wire disposed on the VCONN connection pad and electrically connected to the first power supply port of the active chip.

In one embodiment, the wire set further includes a power transmission unit electrically connected to a power transmission pad of the wire-set connection pad group.

In one embodiment, the wire set further includes a second signal transmission unit. The second signal transmission unit includes a second signal transmission wire electrically connected to a second signal transmission pad of the wire-set connection pad group, and a second drain wire electrically connected to a power transmission pad of the wire-set connection pad group.

In one embodiment, a configuration port of the active chip is electrically connected to a configuration connection pad of the wire-set connection pad group, and the wire set further includes a configuration transmission wire disposed on the configuration connection pad.

In one embodiment, the first connector further includes a plug end. The plug end includes a VCONN terminal electrically coupled to a second power supply port of the active chip.

The present invention further provides a transmission cable. The transmission cable includes a wire set and a first connector disposed at a first end of the wire set. The first connector includes a first connector circuit board having a wire-set connection pad group, and an active chip disposed on the first connector circuit board. A first power supply port of the active chip is electrically connected to a VCONN connection pad of the wire-set connection pad group. The wire set includes a first drain wire electrically connected to the VCONN connection pad, and a second drain wire electrically connected to a power transmission pad of the wire-set connection pad group.

In one embodiment, the first drain wire is disposed on an auxiliary VCONN connection pad of the wire-set connection pad group and is electrically connected to the VCONN connection pad through a first conductive trace of the first connector circuit board. The second drain wire is disposed on an auxiliary power transmission pad of the wire-set connection pad group and is electrically connected to the power transmission pad through a second conductive trace of the first connector circuit board.

In one embodiment, the auxiliary VCONN connection pad is disposed at a first corner position of the first connector circuit board, and the auxiliary power transmission pad is disposed at a second corner position of the first connector circuit board.

In one embodiment, the wire set further includes a VCONN transmission wire disposed on the VCONN connection pad and electrically connected to the first power supply port of the active chip.

In one embodiment, a configuration port of the active chip is electrically connected to a configuration connection pad of the wire-set connection pad group, and the wire set further includes a configuration transmission wire disposed on the configuration connection pad.

In one embodiment, the first connector further includes a plug end. The plug end includes a VCONN terminal electrically coupled to a second power supply port of the active chip.

The present invention further provides a transmission cable. The transmission cable includes a wire set and a USB Type-C connector disposed at a first end of the wire set. The USB Type-C connector includes a connector circuit board having a wire-set connection pad group. The wire set includes a first signal transmission unit. The first signal transmission unit includes a first signal transmission wire electrically connected to a first signal transmission pad of the wire-set connection pad group, and a first drain wire electrically connected to a power transmission pad of the wire-set connection pad group.

In one embodiment, the wire set further includes a power transmission unit electrically connected to the power transmission pad of the wire-set connection pad group.

In one embodiment, the drain wire is disposed on an auxiliary power transmission pad of the wire-set connection pad group and is electrically connected to the power transmission pad through a conductive trace of the first connector circuit board.

In one embodiment, the auxiliary power transmission pad is disposed at a corner position of the first connector circuit board.

As described above, the drain wire can serve as an auxiliary power transmission wire for transmitting a VCONN voltage in direct-current applications. Since the function of the drain wire for removing and/or diverting interference signals is effective in high-frequency applications, the drain wire can still achieve the intended effect under high-frequency conditions. Accordingly, voltage drop at two ends of the transmission cable can be reduced, thereby preventing failure of the active chip or loss of functionality of the transmission cable caused by voltage drop.

### BRIEF DESCRIPTION OF THE DRAWINGS

The drawings provided in the present invention are intended to assist in describing various embodiments of the invention. However, for the purpose of simplifying the drawings and/or highlighting the content to be illustrated, well-known structures and/or elements may be depicted in a simplified schematic manner or may be omitted from the drawings. Moreover, the number of elements shown in the drawings may be singular or plural. The drawings disclosed in the present invention are provided solely for the purpose of illustrating the embodiments and are not intended to limit the scope thereof.

FIG. 1 is a circuit diagram illustrating a conventional transmission cable and an active chip configuration.

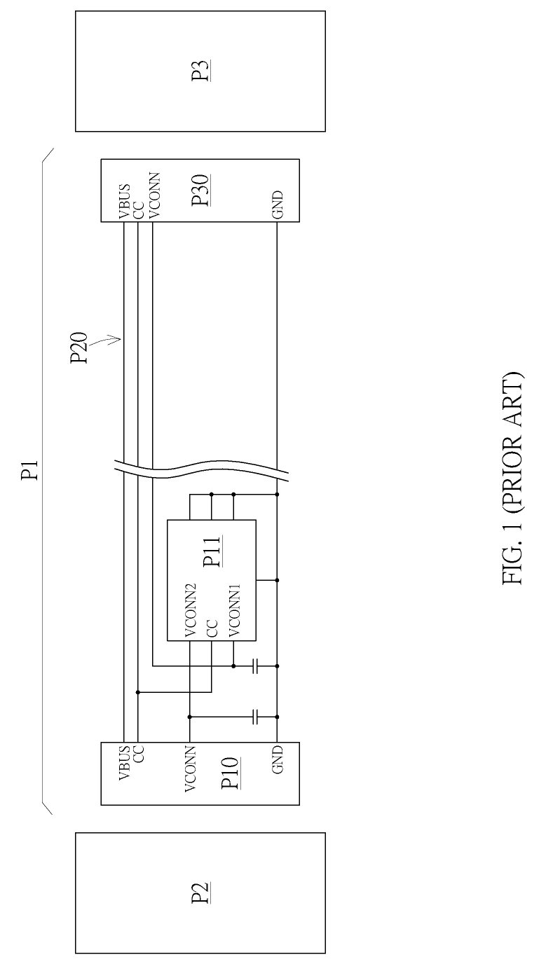

FIG. 2 is a schematic diagram of a transmission cable according to an embodiment of the present invention.

FIG. 3 is a circuit schematic diagram illustrating an active chip and a connector circuit board according to an embodiment of the present invention.

FIG. 4 is a cross-sectional schematic diagram of a wire set according to an embodiment of the present invention.

FIG. 5 is a circuit schematic diagram illustrating an active chip and a connector circuit board according to an embodiment of the present invention.

FIG. 6 is a circuit schematic diagram illustrating an active chip and a connector circuit board according to an embodiment of the present invention.

FIGS. 7A and 7B are schematic diagrams illustrating configurations of a connector circuit board according to an embodiment of the present invention.

FIG. 8 is a schematic diagram of a transmission cable according to an embodiment of the present invention.

FIG. 9 is a schematic diagram illustrating a configuration of a connector circuit board according to an embodiment of the present invention.

### DETAILED DESCRIPTION

Any reference herein to elements designated by terms such as “first,” “second,” and the like generally does not limit the number or order of such elements. Rather, these terms are used merely as convenient labels for distinguishing between two or more elements or instances thereof. Accordingly, it should be understood that the terms “first,” “second,” and the like in the claims do not necessarily correspond to the same terms used in the written description. Further, it should be understood that references to first and second elements do not imply that only two elements may be employed, nor that the first element must precede the second element. As used herein, terms such as “comprising,” “including,” “having,” and “containing” are open-ended terms and therefore mean “including but not limited to”.

The term “connected” as used herein refers to either a direct or an indirect coupling between two structures. For example, in one instance of indirect connection, one structure may be connected to another structure through an intermediate member.

In the present invention, the terms “exemplary” and “for example” are intended to mean “serving as an example, instance, or illustration.” Any embodiment or aspect described as “exemplary” or “for example” should not necessarily be interpreted as being preferred or advantageous over other aspects of the invention. The terms “about” or “approximately,” when used herein with respect to a specified value or characteristic, are intended to indicate within a certain range of the specified value or characteristic (e.g., within 10 %).

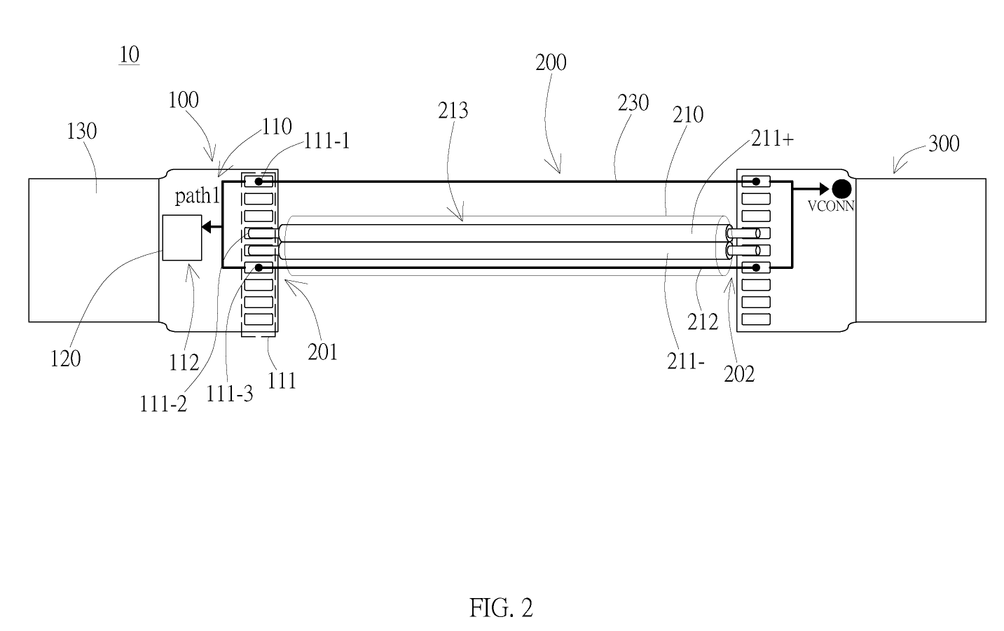

In a specific embodiment of the present invention, a transmission cable is provided. Referring to FIG. 2, the transmission cable 10 includes a wire set 200 and a first connector 100 disposed at a first end 201 of the wire set 200. The first connector 100 includes a first connector circuit board 110 having a wire-set connection pad group 111, and an active chip 120 disposed on the first connector circuit board 110. A first power supply port VCONN1 of the active chip 120 is electrically connected to a VCONN connection pad 111-1 of the wire-set connection pad group 111. The wire set 200 includes a first signal transmission unit 210. The first signal transmission unit 210 includes a first signal transmission wire 211 and a first drain wire 212. The first signal transmission wire 211 is electrically connected to a first signal transmission pad 111-2 of the wire-set connection pad group 111, and the first drain wire 212 is electrically connected to the VCONN connection pad 111-1.

In an embodiment, the transmission cable 10 is, for example, configured to connect two devices to perform data transmission, charging (e.g., based on a USB Power Delivery (PD) protocol), and/or audio/video transmission. The transmission cable 10 includes the wire set 200, the first connector 100 disposed at the first end 201 of the wire set 200, and a second connector 300 disposed at a second end 202 of the wire set 200. In an embodiment, the wire set 200 is configured to be mounted on the first connector circuit board 110 of the first connector 100 by soldering or other suitable connection means, but is not limited thereto.

In an embodiment, the first connector 100 further includes a plug end 130. In the embodiment, the plug end 130 is selected from any conventional plug, such as HDMI, DisplayPort (DP), USB (Type-C), or the like, and includes a corresponding external housing. The external housing is preferably electrically connected to a ground point, but is not limited thereto. In an embodiment, the external housing serves as a protective structure to protect terminals within the plug end 130, or may function as a keying mechanism when the plug end 130 is inserted into a corresponding receptacle. For example, a configuration of the external housing may correspond to a configuration of the receptacle so as to prevent insertion into an incorrect receptacle or insertion in an incorrect orientation, but is not limited thereto. The electrical terminals of the plug end 130 may be electrically connected to the first connector circuit board 110 through conventional connection means.

Taking the first connector circuit board 110 as an example, in an embodiment, the first connector circuit board 110 is a printed circuit board (PCB) or any other suitable circuit carrier. The first connector circuit board 110 includes a wire-set connection pad group 111 and a chip connection pad group 112 (located beneath the active chip 120 in FIG. 2). The wire-set connection pad group 111 and the chip connection pad group 112 are conductive pads disposed on a surface of the first connector circuit board 110. The conductive pads for connection may be formed on a conductor-clad substrate by conventional manufacturing processes such as engraving, photolithography, or etching. In an embodiment, various wires of the wire set 200 may be mounted on the wire-set connection pad group 111 by soldering or other suitable means, and the active chip 120 may be mounted on the chip connection pad group 112 by surface-mount soldering, pin soldering, or other suitable mounting techniques.

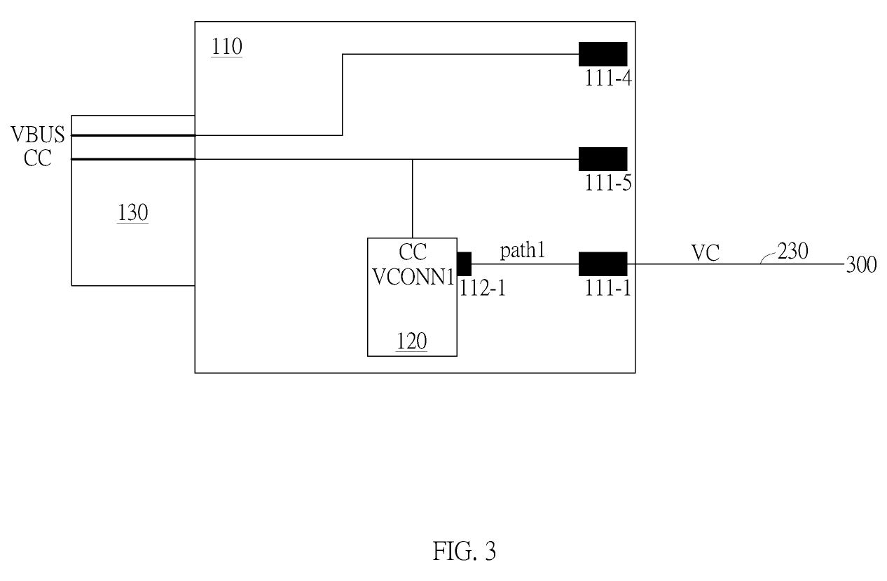

Referring to FIG. 3, the wire-set connection pad group 111 includes a VCONN connection pad 111-1 and a first signal transmission pad 111-2. The chip connection pad group 112 includes a first power supply pad 112-1 corresponding to the first power supply port VCONN1 of the active chip 120. The VCONN connection pad 111-1 and the first power supply pad 112-1 are electrically connected to each other through a conductor path (path1) predefined in the first connector circuit board 110. When the VCONN connection pad 111-1 receives chip power supply (VC) from the second connector 300 via a VCONN transmission wire 230, the chip power supply (VC) can be provided to the active chip 120 through the conductor path (path1).

The active chip 120 may, for example, be an electronic marker (E-marker) chip used for electronic identification, or a redriver chip used for signal relay processing, but is not limited thereto. The active chip 120 may be disposed at one end or both ends of the transmission cable 10. In other words, the active chip 120 may be disposed only in the first connector 100, or the same or different active chip 120 may also be disposed in the second connector 300.

When the active chip 120 needs to operate and requires power, required chip power (VC) may be obtained from the plug end 130 of the first connector 100 or from the second connector 300. Specifically, the first power supply port VCONN1 of the active chip 120 is electrically connected to the VCONN connection pad 111-1 and receives the chip power (VC) from the second connector 300. Alternatively, the active chip 120 may also be connected to the plug end 130 of the first connector 100 and receive the chip power (VC) supplied from the plug end 130 of the first connector 100.

In an embodiment, the wire set 200 may be formed by covering various types of core wires (such as single-core wires, coaxial cables, twisted pairs, or stranded wires) with insulation layers. It should be noted that the number and types of core wires in the wire set 200 are not limited. Preferably, the core wires of the wire set 200 may be selected according to specifications of the first connector 100 and/or the second connector 300, but are not limited thereto. As will be appreciated by those skilled in the art, the wire set 200 may further include other wires or layers, which are described below by way of example.

The first signal transmission unit 210 of the wire set 200 includes a first signal transmission wire 211 and a first drain wire 212. The first signal transmission wire 211 is configured to transmit signals and is electrically connected to the first signal transmission pad 111-2 of the wire-set connection pad group 111. For example, when the first signal transmission unit 210 is configured to transmit differential signals, the first signal transmission wire 211 may be a twisted-pair set (211+/211−) for transmitting the differential signals. The first drain wire 212 is a bare conductor wire (i.e., without an insulation layer) and is preferably twisted together with the first signal transmission wire 211 (or the twisted-pair set (211+/211−)) and covered by an insulation layer 213 with the first signal transmission wire 211. An exemplary function of the first drain wire 212 is to remove and/or divert interference signals associated with the first signal transmission unit 210. The interference signals may include noise generated by interaction between the first signal transmission wire 211 and other wires (e.g., crosstalk noise), or noise coupled into the first signal transmission wire 211 from outside the first signal transmission unit 210. The first drain wire 212 is electrically connected to the VCONN connection pad 111-1, such that the first drain wire 212 can be used, in direct-current (DC) applications, to transmit the chip power (VC) required by the active chip 120 (e.g., 5 V or 3.3 V DC). Accordingly, the required wire gauge of the VCONN transmission wire 230 for transmitting the chip power (VC) in the wire set 200 can be reduced, thereby reducing voltage drop of the chip power (VC) between two ends of the transmission cable 10. In other words, compared with conventional configurations, under the same length requirement, the configuration of the present invention can reduce the required wire gauge of the VCONN transmission wire 230 used to transmit the chip power (VC), or can minimize voltage drop when using a VCONN transmission wire 230 of the same wire gauge. On the other hand, in high-frequency applications (e.g., signals of 1 GHz or higher), the first drain wire 212 can still perform its original function, such as diverting interference signals of the first signal transmission unit 210 via the VCONN connection pad 111-1.

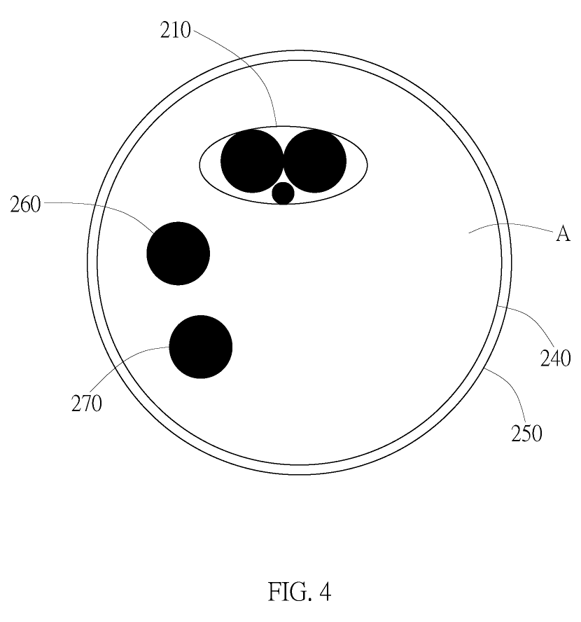

In an embodiment, the wire set 200 further includes other types of wires. FIG. 4 illustrates an exemplary cross-sectional structure of the wire set 200. In one embodiment, the wire set 200 further includes a shielding layer 240 that at least partially covers the first signal transmission unit 210. For example, the shielding layer 240 may be a conductive material such as aluminum foil or copper braid and may be disposed at a relatively outer layer of the wire set 200. When the wire set 200 has a circular cross section, an outermost layer may be an insulation jacket 250, followed by the shielding layer 240. The shielding layer 240 may have a circular cross section defining a cavity (A), in which the first signal transmission unit 210 and other wires of the wire set 200 are disposed. It should be noted that the cavity (A) illustrated in FIG. 4 is merely schematic, and the size of the cavity (A) may be only slightly larger than the cross-sectional area of the first signal transmission unit 210 due to tight wrapping of the shielding layer 240 and the insulation jacket 250. The shielding layer 240 is electrically connected to a ground terminal through the first connector circuit board 110, and may also be electrically connected to the ground terminal through an external housing or other common-ground components. By being electrically connected to the ground terminal, the shielding layer 240 provides a shielding function against external noise to prevent interference with signal transmission inside the wire set 200. Compared with a conventional configuration in which drain wires are electrically connected to ground terminals, ground terminals at two ends of the transmission cable 10 can be effectively electrically connected through the shielding layer 240. Moreover, since the intrinsic impedance of the shielding layer 240 is much smaller than that of other wires in the wire set 200, the drain wires can be electrically connected to the VCONN connection pad 111-1 to transmit the chip power (VC) required by the active chip 120 without affecting, or with only minimal effect on, grounding between two ends of the transmission cable 10.

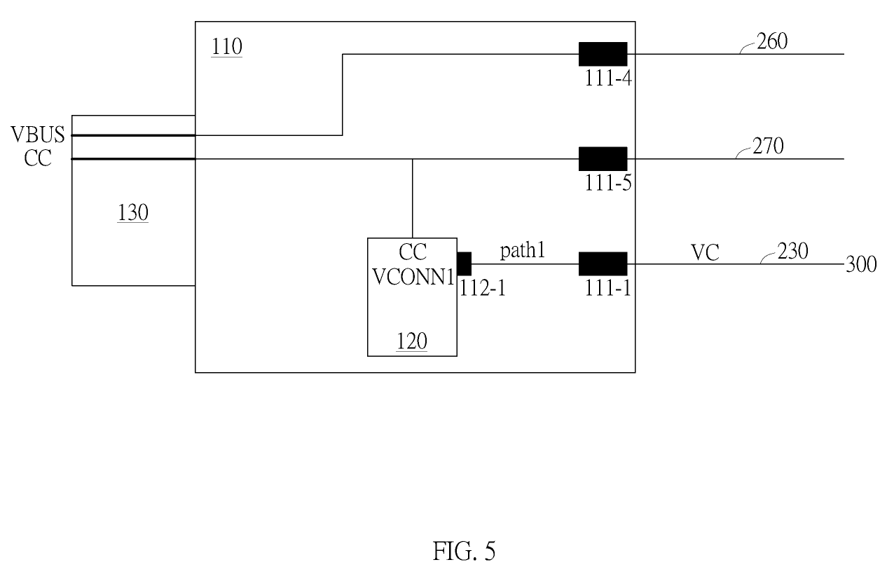

In one embodiment, referring to FIG. 5, the wire set 200 further includes a power transmission unit 260. The power transmission unit 260 is electrically connected to a power terminal (VBUS) through a power transmission pad 111-4 of the wire-set connection pad group 111 on the first connector circuit board 110. The power transmission unit 260 may be, for example, a power-carrying wire (e.g., a copper wire) in the wire set 200. The power transmission unit 260 is electrically coupled to the power terminal (VBUS) via the power transmission pad 111-4, such that the power transmission unit 260 serves as a primary carrier for power transmission. The power terminal (VBUS) may be provided, for example, by a device connected to the first connector 100. In one application example, after completion of a Power Delivery (PD) protocol negotiation, the power transmission unit 260 can perform power transmission.

In one embodiment, the wire set 200 further includes a configuration transmission wire 270 disposed on a configuration connection pad 111-5. A configuration port (CC) of the active chip 120 is electrically connected to the configuration connection pad 111-5 of the wire-set connection pad group 111. Specifically, a device connected to the transmission cable 10 may transmit request messages to the active chip 120 through the configuration transmission wire 270. After receiving the request messages through the configuration port (CC), the active chip 120 in the transmission cable 10 can provide information related to the active chip 120 or the transmission cable 10 to facilitate subsequent transmission operations.

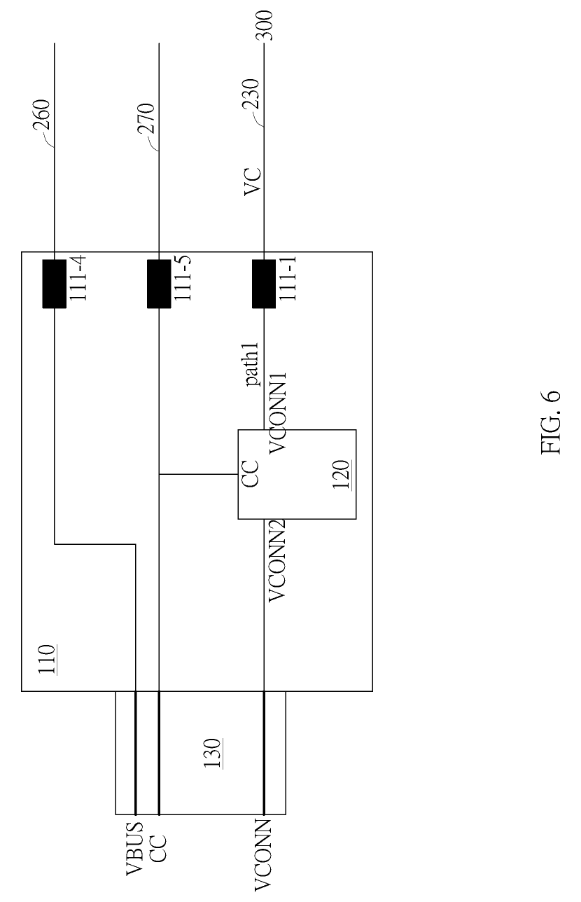

In one embodiment, the active chip 120 further includes a second power supply port (VCONN2). Referring to FIG. 6, the second power supply port (VCONN2) is electrically connected to a VCONN terminal of the plug end 130. In this embodiment, the first power supply port VCONN1 of the active chip 120 is configured to receive chip power (VC) supplied by a device connected to the second connector 300, while the second power supply port (VCONN2) is configured to receive chip power (VC) supplied by a device connected to the first connector 100. After determining a source device of the chip power (VC) through a protocol (e.g., a PD protocol), the active chip 120 may select one of the first power supply port VCONN1 and the second power supply port VCONN2 to supply power to the active chip 120.

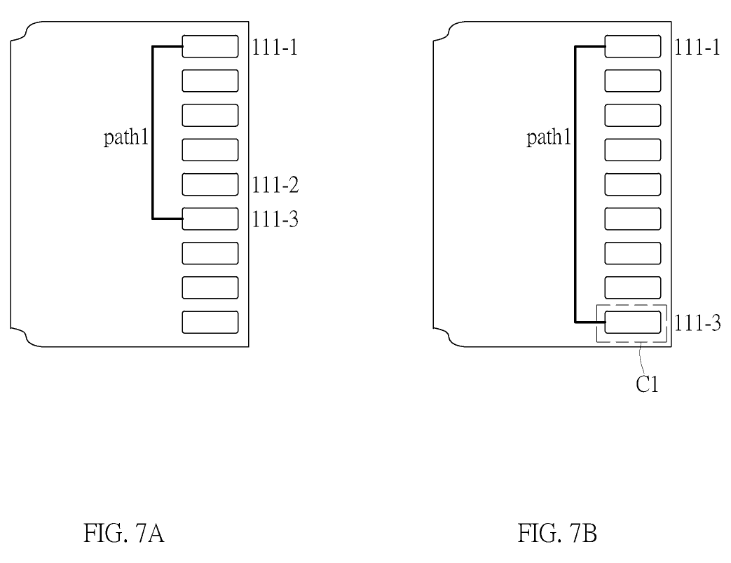

In an embodiment in which the first connector circuit board 110 is connected to the wire set 200, referring to FIGS. 7A and 7B, the first drain wire 212 is disposed on an auxiliary VCONN connection pad 111-3 of the wire-set connection pad group 111, and is electrically connected to the VCONN connection pad 111-1 through a conductive trace (path1) of the first connector circuit board 110. In the embodiment illustrated in FIG. 7A, the auxiliary VCONN connection pad 111-3 is disposed adjacent to the first signal transmission pad 111-2. In the embodiment illustrated in FIG. 7B, the auxiliary VCONN connection pad 111-3 is disposed at a corner position (C1) of the first connector circuit board 110. By using the auxiliary VCONN connection pad 111-3, electrical interference between the first drain wire 212 and the VCONN connection pad 111-1 can be reduced, and the auxiliary VCONN connection pad 111-3 and the VCONN connection pad 111-1 can be arranged closer to or farther from each other according to different circuit requirements.

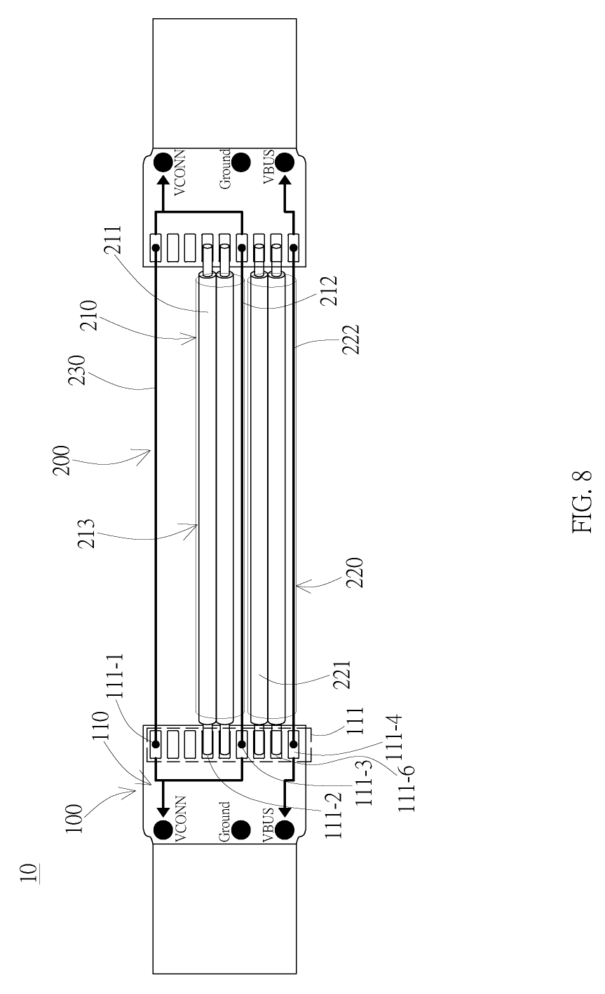

In one embodiment, remaining drain wires in the wire set 200 may be selectively electrically connected to a ground terminal, a power terminal (VBUS), or a VCONN terminal. For example, referring to FIG. 8, the transmission cable 10 includes a wire set 200 and a first connector 100 disposed at a first end 201 of the wire set 200. The first connector 100 includes a first connector circuit board 110 having a wire-set connection pad group 111, and an active chip 120 disposed on the first connector circuit board 110. A first power supply port VCONN1 of the active chip 120 is electrically connected to a VCONN connection pad 111-1 of the wire-set connection pad group 111. The wire set 200 includes a first drain wire 212 electrically connected to the VCONN connection pad 111-1, and a second drain wire 222 electrically connected to a power transmission pad 111-4 of the wire-set connection pad group 111. Specifically, the wire set 200 further includes a second signal transmission unit 220. The second signal transmission unit 220 includes a second signal transmission wire 221 electrically connected to a second signal transmission pad 111-6 of the wire-set connection pad group 111, and the second drain wire 222 electrically connected to the power transmission pad 111-4. By electrically connecting the second drain wire 222 to the power terminal (VBUS), the required wire gauge of the power transmission unit 260 can be reduced accordingly, thereby reducing voltage drop between two ends of the power transmission unit 260.

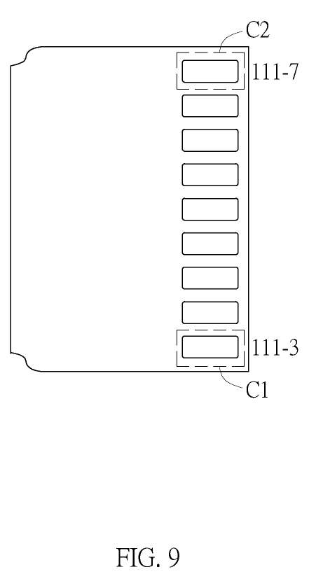

In this embodiment, referring to FIG. 9 for an example in which the first connector circuit board 110 is connected to the wire set 200, the first drain wire 212 is disposed on an auxiliary VCONN connection pad 111-3 and is electrically connected to the VCONN connection pad 111-1 through a first conductive trace of the first connector circuit board 110. The second drain wire 222 is disposed on an auxiliary power transmission pad 111-7 and is electrically connected to the power transmission pad 111-4 through a second conductive trace of the first connector circuit board 110. The auxiliary VCONN connection pad 111-3 is disposed at a first corner position (C1) of the first connector circuit board 110, and the auxiliary power transmission pad 111-7 is disposed at a second corner position (C2) of the first connector circuit board 110. In this manner, the auxiliary power transmission pad 111-7 used for power transmission can be effectively distinguished from the auxiliary VCONN connection pad 111-3 used for transmitting VCONN power, thereby reducing soldering difficulty.

In one embodiment, the present invention provides a transmission cable. The transmission cable includes a wire set and a USB Type-C connector 100 disposed at a first end of the wire set. The USB Type-C connector 100 includes a connector circuit board having a wire-set connection pad group. The wire set includes a first signal transmission unit. The first signal transmission unit includes a first signal transmission wire electrically connected to a first signal transmission pad of the wire-set connection pad group, and a first drain wire electrically connected to a power transmission pad of the wire-set connection pad group. By using the drain wire as part of a power terminal (VBUS), the required wire gauge of the power transmission unit can be reduced accordingly, thereby reducing voltage drop between two ends of the power transmission unit.

As described above, in direct-current applications, the drain wire can serve as an auxiliary power transmission wire for transmitting a VCONN voltage. Since the function of the drain wire to remove and/or divert interference signals is effective in high-frequency applications, the drain wire can still achieve the intended effect under high-frequency conditions. Accordingly, voltage drop at two ends of the transmission cable can be reduced, thereby preventing failure of the active chip 120 or loss of functionality of the transmission cable 10 caused by voltage drop.

The foregoing description of the present invention is provided to enable a person skilled in the art to make or use the invention. Various modifications to the invention will be readily apparent to those skilled in the art, and the generic principles defined herein may be applied to other variations without departing from the spirit or scope of the invention. Thus, the present invention is not intended to be limited to the embodiments described herein but is to be accorded the broadest scope consistent with the principles and novel features disclosed.

What is claimed is:

1. A transmission cable, comprising:
a first connector, including:
a first connector circuit board having a wire-set connection pad group; and
an active chip disposed on the first connector circuit board, wherein a first power supply port of the active chip is electrically connected to a VCONN connection pad of the wire-set connection pad group; and
a wire set, wherein the first connector is disposed at a first end of the wire set, the wire set including:
a first signal transmission unit, including:
a first signal transmission wire electrically connected to a first signal transmission pad of the wire-set connection pad group; and
a first drain wire electrically connected to the VCONN connection pad.

2. The transmission cable according to claim 1, wherein the wire set further includes:
a shielding layer at least partially covering the signal transmission unit and electrically connected to a ground pad of the wire-set connection pad group.

3. The transmission cable according to claim 1, wherein the first drain wire is disposed on an auxiliary VCONN connection pad of the wire-set connection pad group and is electrically connected to the VCONN connection pad via a conductive trace of the first connector circuit board.

4. The transmission cable according to claim 3, wherein the auxiliary VCONN connection pad is disposed adjacent to the first signal transmission pad.

5. The transmission cable according to claim 3, wherein the auxiliary VCONN connection pad is disposed at a corner position of the first connector circuit board.

6. The transmission cable according to claim 1, wherein the wire set further includes:
a VCONN transmission wire disposed on the VCONN connection pad and electrically connected to the first power supply port of the active chip.

7. The transmission cable according to claim 1, wherein the wire set further includes:
a power transmission unit electrically connected to a power transmission pad of the wire-set connection pad group.

8. The transmission cable according to claim 1, wherein the wire set further includes:
a second signal transmission unit, including:
a second signal transmission wire electrically connected to a second signal transmission pad of the wire-set connection pad group; and
a second drain wire electrically connected to a power transmission pad of the wire-set connection pad group.

9. The transmission cable according to claim 1, wherein a configuration port of the active chip is electrically connected to a configuration connection pad of the wire-set connection pad group; and
wherein the wire set further includes a configuration transmission wire disposed on the configuration connection pad.

10. The transmission cable according to claim 1, wherein the first connector further includes:
a plug end having a VCONN terminal electrically coupled to a second power supply port of the active chip.

11. A transmission cable, comprising:
a first connector, including:
a first connector circuit board having a wire-set connection pad group; and
an active chip disposed on the first connector circuit board, wherein a first power supply port of the active chip is electrically connected to a VCONN connection pad of the wire-set connection pad group; and
a wire set, wherein the first connector is disposed at a first end of the wire set, the wire set including:
a first drain wire electrically connected to the VCONN connection pad; and
a second drain wire electrically connected to a power transmission pad of the wire-set connection pad group.

12. The transmission cable according to claim 11, wherein the first drain wire is disposed on an auxiliary VCONN connection pad of the wire-set connection pad group and is electrically connected to the VCONN connection pad via a first conductive trace of the first connector circuit board; and
wherein the second drain wire is disposed on an auxiliary power transmission pad of the wire-set connection pad group and is electrically connected to the power transmission pad via a second conductive trace of the first connector circuit board.

13. The transmission cable according to claim 12, wherein the auxiliary VCONN connection pad is disposed at a first corner position of the first connector circuit board, and the auxiliary power transmission pad is disposed at a second corner position of the first connector circuit board.

14. The transmission cable according to claim 11, wherein the wire set further includes:
a VCONN transmission wire disposed on the VCONN connection pad and electrically connected to the first power supply port of the active chip.

15. The transmission cable according to claim 11, wherein a configuration port of the active chip is electrically connected to a configuration connection pad of the wire-set connection pad group; and
wherein the wire set further includes a configuration transmission wire disposed on the configuration connection pad.

16. The transmission cable according to claim 11, wherein the first connector further includes:
a plug end having a VCONN terminal electrically coupled to a second power supply port of the active chip.

17. A transmission cable, comprising:
a USB Type-C connector, including:
a connector circuit board having a wire-set connection pad group; and
a wire set, wherein the USB Type-C connector is disposed at a first end of the wire set, the wire set including:
a first signal transmission unit, including:
a first signal transmission wire electrically connected to a first signal transmission pad of the wire-set connection pad group; and
a first drain wire electrically connected to a power transmission pad of the wire-set connection pad group.

18. The transmission cable according to claim 17, wherein the wire set further includes:
a power transmission unit electrically connected to the power transmission pad of the wire-set connection pad group.

19. The transmission cable according to claim 17, wherein the first drain wire is disposed on an auxiliary power transmission pad of the wire-set connection pad group and is electrically connected to the power transmission pad via a conductive trace of the connector circuit board.

20. The transmission cable according to claim 19, wherein the auxiliary power transmission pad is disposed at a corner position of the connector circuit board.
